(19) United States
(12) Patent Application Publication
(10) Pub. No.: US 2022/0005399 A1
(43) Pub. Date: Jan. 6, 2022

(54) Display device having functionality of blue light filtering

(71) Applicant: NATIONAL TSING HUA UNIVERSITY, Hsinchu City (TW)

(72) Inventor: JWO-HUEI JOU, Hsinchu City (TW)

(21) Appl. No.: 17/028,798

(22) Filed: Sep. 22, 2020

(30) Foreign Application Priority Data
Jul. 1, 2020 (TW) 109122201

(51) Int. Cl. G09G 3/20; G09G 3/14

(52) U.S. Cl. CPC G09G 3/2088; G09G 2360/144; G09G 3/14

(57) ABSTRACT

A device having functionality of eye protection is disclosed, which principally comprises a display main body and a light parameter regulating unit. The light parameter regulating unit is adopted for regulating a color temperature (CT) of a specific light that is radiated from the display main body down to be below 3000K. Moreover, the specific light is eventually regulated down to have a minimum CT of 2000K, and an illuminance of the specific light is steppedly dimmed to be close to 0 lx. Experimental data have proved that, after being applied with the light parameter regulating process, a value of MPE of the specific light is largely increased, and a ratio of MSS is significantly lowered. In addition, when a user is watching the display device, the illuminance of the specific light can also be automatically adjusted to approach an illuminance of an ambient light.

### BACKGROUND OF THE INVENTION

### 1. Field of the Invention

The present invention relates to the technology field of human eyes protection, and more particularly to a display device having functionality of eye protection.

### 2. Description of the Prior Art

It is well known that natural light consists of visible and invisible lights, wherein infrared (IR) light and ultraviolet (UV) light are two of the invisible lights. On the other hand, it is understood that the visible lights comprise red, orange, yellow, green, blue, indigo, and purple lights. Retina is an important part of human eyes, and has specific function of converting light signal to neural signal. It is known that, the specific light irradiated from sun commonly has a continuous spectrum. Differing from the sunlight, however, an LED lighting element that is configured for emitting an artificial light (i.e., white light) has been widely applied in various illumination devices, backlight modules and self-luminous display panels. FIG. 1 illustrates one diagram for showing an emission spectrum of a white light LED. On the other hand, FIG. 2 shows one diagram for showing an emission spectrum of a LCD device. From FIG. 1, it is found that the white light emitted by the LED lighting element has a discontinuous spectrum that merely contains visible wavelengths in a range from 430 nm to 680 nm. Moreover, FIG. 1 and FIG. 2 both show that the artificial light specifically contains a high-intensity blue light (400 nm-500 nm).

Research reports have indicated that, a proper illumination from blue light can lift a person's spirits and make the person has a feeling of pleasure. However, other different research reports conclude that, too much illumination of blue light would bring light pollution, disturbance of human biological clock, loss of sleep, and eye damage on. To be more seriously, too much illumination of blue light may cause a man suffer from macular degeneration. As explained in more detail below, blue light is the part of the spectrum with the highest energy content and that still can reach the retina. It has been studied that, photochemical means that due to the high energy content of the incoming light some chemical reactions take place on the retina, eventually bringing photoretinitis on, which is a retinal lesion induced by light, in particular the high-energy blue light. Herein, it needs to introduce that, how to calculate a specific light's maximum permissible exposure (MPE) limit for retina has been disclosed in American National Standards Institute (ANSI) Z136.1-1. Nowadays, MPE limit is usually expressed in terms of the allowable exposure time (in seconds) for a given irradiance (in watts/cm²) at a particular wavelength. Therefore, a specific light's MPE limit value would grow with the increase of the illuminance thereof. Of course, the MPE limit of a short-wavelength light is certainly higher than that of a long-wavelength light in case of the forgoing two lights being modulated to have the same illuminance.

It is worth noting that, modem people every day have a considerably long elapsed time of using their 3C products (like laptop computer, smart phone or tablet PC), ophthalmologist, such that eyewear manufacturing companies and lamp manufacturing companies have made great efforts to propaganda the important issue of blue light hazard. Nowadays, blue-light blocking eyeglass lens, blue-light blocking (filtering) screen protector and blue light filter application (App) are three of the blue light filtering (blocking) products that are widely used by people. It is a pity that, however, each of the forgoing three blue light blocking products merely exhibits a limited human eyes protection effect due to the fact that they cannot effectively filter or block blue light and/or purple light.

From above descriptions, it is clear that there is still a lack of a best human eyes protection solution. In view of that, inventors of the present application have made great efforts to make inventive research and eventually provided a display device having functionality of eye protection.

### SUMMARY OF THE INVENTION

The primary objective of the present invention is to disclose a display device having functionality of eye protection, which principally comprises a display main body and a light parameter regulating unit. In which, the light parameter regulating unit is disposed for being faced to a display screen of the display main body, so as to apply a light parameter regulating process to a specific light radiated form the display screen. After a treatment of the light parameter regulating process, a color temperature (CT) of the specific light is regulated down to be below 3000K, and an illuminance of the specific light is steppedly dimmed to be close to 0 lx. Moreover, by the light parameter regulating process, the specific light is regulated down to have a minimum CT of 2000K. On the other hand, experimental data have proved that, after the treatment of the light parameter regulating process, a value of MPE (maximum permissible exposure time for retina) of the specific light is largely increased, and a ratio of MSS (melatonin suppression) is significantly lowered. In addition, in case of a user being watching the display device, the illuminance of the specific light can also be automatically adjusted to approach an illuminance of an ambient light, such that not only the health of eyes and physiologies of the user can be well protected, but also the user is led to have a good visual balance.

In order to achieve the primary objective of the present invention, inventors of the present invention provide a first embodiment for the display device having functionality of eye protection, comprising:
a display main body, having a display screen and a display processor; and
a light parameter regulating unit, being disposed to face the display screen, and being configured for applying a light parameter regulating process to a specific light that is radiated from the display screen, so as to regulate a color temperature of the specific light down to be below 3000K;
wherein the specific light is eventually regulated to have a minimum color temperature of 2000K.

For achieving the primary objective of the present invention, inventors of the present invention provide a second embodiment for the display device having functionality of eye protection, comprising:
a display main body, having a display screen and a display processor; and
a light parameter regulating unit, being disposed to face the display screen, and being configured for applying a light parameter regulating process to a specific light that is radiated from the display screen, so as to make a first illuminance of the specific light be steppedly dimmed to be close to 0 lx.

In order to achieve the primary objective of the present invention, inventors of the present invention provide a third embodiment for the display device having functionality of eye protection, comprising:
a display main body, having a display screen and a display processor; and
a light parameter regulating unit, being disposed to face the display screen, and being configured for applying a light parameter regulating process to a specific light that is radiated from the display screen, thereby regulating a color temperature of the specific light down to be below 3000K, and making a first illuminance of the specific light be steppedly dimmed to approach 0 lx;
wherein the specific light is eventually regulated to have a minimum color temperature of 2000K.

In one embodiment, a fixing unit is connected the display main body, and is used for supporting the light parameter regulating unit, so as to make the light parameter regulating unit be disposed to face the display screen of the display main body.

In one embodiment, the light parameter regulating unit is directly attached onto the display screen of the display main body.

In one embodiment, after the light parameter regulating process is completed, a value of maximum permissible exposure time (MPE) of the specific light being increased by a ratio that is in a range between 20 and 100.

In one embodiment, after the light parameter regulating process is completed, a value of melatonin suppression (MSS) ratio of the specific light being lowered by a ratio that is in a range between 1 and 5.

In one embodiment, the forgoing display device is integrated in an electronic device that is selected from the group consisting of television, laptop computer, all-in-one computer, tablet computer, and smartphone.

In one embodiment, the forgoing display device further comprises;
an ambient light sensing unit; and
a microprocessor, being integrated in the display main body, and being coupled to the ambient light sensing unit and the display processor;
wherein in case of an illuminance difference between a first illuminance of the specific light and a second illuminance of an ambient light sensed by the ambient light sensing unit being greater than a reference illuminance difference, the microprocessor transmits a illuminance regulating signal to the display processor, such that the first illuminance of the specific light is adjusted to approach the second illuminance of the ambient light.

### BRIEF DESCRIPTION OF THE DRAWINGS

The invention as well as a preferred mode of use and advantages thereof will be best understood by referring to the following detailed description of an illustrative embodiment in conjunction with the accompanying drawings, wherein:

FIG. 1 shows a diagram for showing an emission spectrum of a white light LED;

FIG. 2 shows a diagram for showing an emission spectrum of a LCD device.

FIG. 3 shows a schematic stereo diagram of a display device having functionality of eye protection according to the present invention;

FIG. 4 shows a schematic stereo diagram of the display device having functionality of eye protection according to the present invention; and

FIG. 5 shows a block diagram of a display main body of the display device having functionality of eye protection.

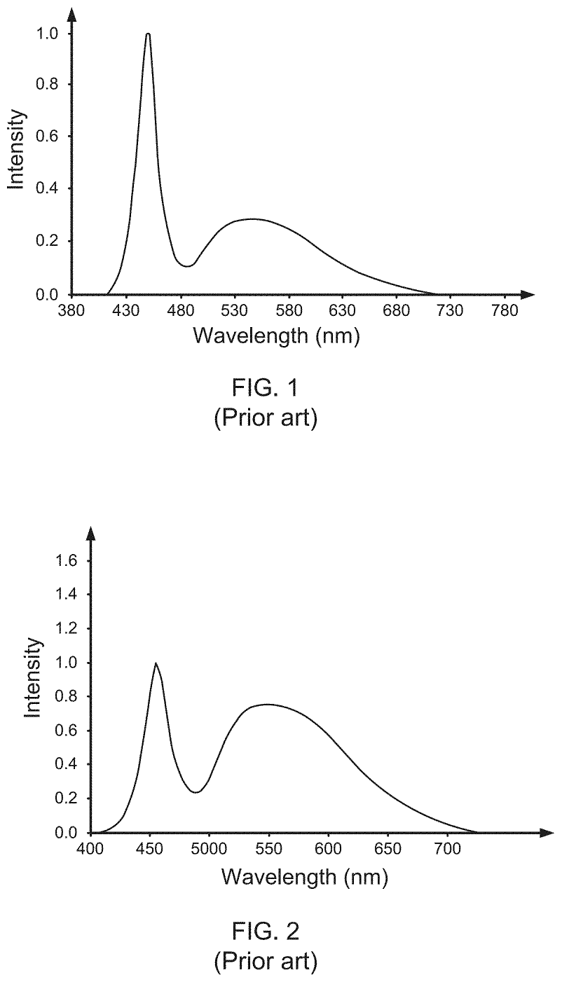

### DETAILED DESCRIPTION OF THE PREFERRED EMBODIMENTS

To more clearly describe a display device having functionality of eye protection disclosed by the present invention, embodiments of the present invention will be described in detail with reference to the attached drawings hereinafter.

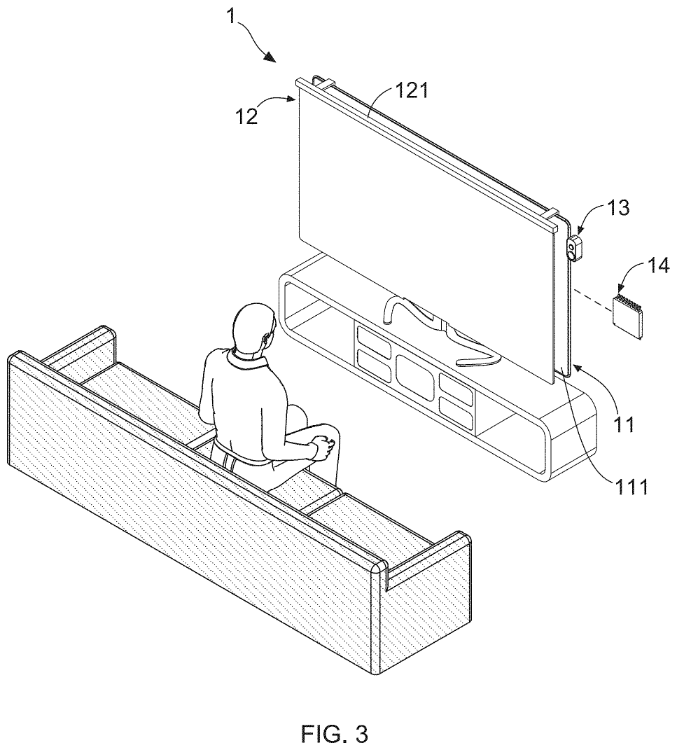

With reference to FIG. 3, there is shown a schematic stereo diagram of a display device having functionality of eye protection according to the present invention. As FIG. 3 shows, the present invention discloses a display device 1 having functionality of eye protection, which can be integrated in an electronic device such as a television. According to the present invention, the display device 1 principally comprises a display main body 11 and a light parameter regulating unit 12. In which, the display main body 11 has a display screen 111 and a display processor 112, and the light parameter regulating unit 12 is disposed to face the display screen 111. Particularly, the light parameter regulating unit 12 is configured for applying a light parameter regulating process to a specific light that is radiated from the display screen 111, so as to regulate a color temperature of the specific light down to be below 3000K. It is worth further explaining that, the specific light is eventually regulated to have a minimum color temperature of 2000K. Moreover, by the light parameter regulating process, a first illuminance of the specific light would be steppedly dimmed to be close to 0 lx in response to an ambient light.

In addition, after the light parameter regulating process is completed, a value of maximum permissible exposure time (MPE) of the specific light is increased by a ratio that is in a range between 20 and 100. Moreover, after the light parameter regulating process is completed, a value of melatonin suppression (MSS) ratio of the specific light is simultaneously lowered by a ratio that is in a range between 1 and 5.

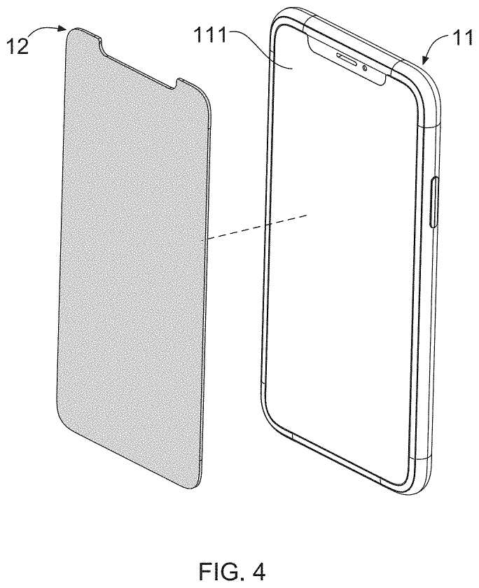

It should be understood that, the practicable embodiment of the display device 1 having functionality of eye protection is not particularly limited. As FIG. 3 shows, in one practicable embodiment, a fixing unit 121 is connected the display main body 11 (i.e., television), and is used for supporting the light parameter regulating unit 12, so as to make the light parameter regulating unit 12 be disposed to face the display screen 111 of the display main body 11. On the other hand, FIG. 4 shows a schematic stereo diagram of the display device having functionality of eye protection according to the present invention. As FIG. 4 shows, in other practicable embodiment, the light parameter regulating unit 12 is directly attached onto the display screen 111 of the display main body 11. Moreover, FIG. 4 also depicts that the display main body 11 is a smartphone.

Therefore, from FIG. 3 and FIG. 4, it is further understood that the forgoing display device 1 can be integrated in various electronic devices, including television, smartphone, laptop computer, all-in-one computer, and tablet computer. On the other hand, the practicable embodiment of the light parameter regulating unit 12 is also not particularly limited. In one practicable embodiment, the light parameter regulating unit 12 can be a color temperature lowering film, an optical filter film with functionality of short-wavelength light filtering, and a wavelength conversion film.

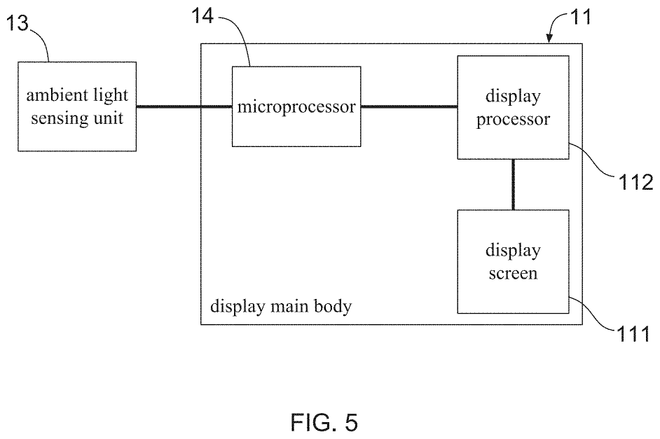

With reference to FIG. 3 again, and please simultaneously refer to FIG. 5 showing a block diagram of a display main body of the display device having functionality of eye protection. As FIG. 3 and FIG. 5 show, the display device 1 of the present invention further comprises an ambient light sensing unit 13 and a microprocessor 14. In which, the microprocessor 14 is integrated in the display main body 11 (i.e., television), and is coupled to the ambient light sensing unit 13 and the display processor 112. By such arrangement, in case of an illuminance difference between a first illuminance of the specific light and a second illuminance of an ambient light sensed by the ambient light sensing unit 13 is greater than a reference illuminance difference, the microprocessor 14 transmits a illuminance regulating signal to the display processor 112, such that the first illuminance of the specific light is adjusted to approach the second illuminance of the ambient light. As such, when a user is watching the display device 1, the illuminance of the specific light can also be automatically adjusted to approach the illuminance of the ambient light, such that not only the health of eyes and physiologies of the user can be well protected, but also the user is led to have a good visual balance.

### Experiment Embodiment

In experiment, brand A smartphone is taken as a control group, and brand A smartphone that is attached with a color temperature lowering film (i.e., light parameter regulating unit 12) on a display screen thereof is taken as an experimental group. Experiment data are recorded in following Table (1).

TABLE 1

Subject

| Measurement items | Control group | Experimental group |
|---|---|---|
| Illuminance (lx) | 427 | 60 |
| Color temperature (K) | 8129 | 1886 |
| MPE (second) | 259 | 23680 |
| MSS (%) | 69 | 26 |
| CIE coordinate (x, y) | (0.29, 0.32) | (0.54, 0.41) |

The experiment data of Table (1) have revealed that, the illuminance of a first light that is radiated from the experimental group is regulated down by a ratio of 7.12 compared to the illuminance of a second light that is radiated from the control group. Moreover, the color temperature of the first light is also regulated down to be below 2000K. On the other hand, the experiment data of Table (1) have revealed that, after the light parameter regulating process is completed, a value of maximum permissible exposure time (MPE) of the first light is increased by a ratio of 91.43, and a value of melatonin suppression (MSS) ratio of the first light is simultaneously lowered by a ratio of 2.65.

The above description is made on embodiments of the present invention. However, the embodiments are not intended to limit scope of the present invention, and all equivalent implementations or alterations within the spirit of the present invention still fall within the scope of the present invention.

1. A display device having functionality of eye protection, comprising:
a display device, being disposed in an environment, and having a display screen and a display processor; and
a color temperature regulating unit, being disposed to face the display screen, and being configured to down regulate a color temperature and a first illuminance of a colored light radiated from the display screen; wherein a value of melatonin suppression (MSS) of the colored light is significantly lowered in case of the color temperature of the colored light being down regulated to be in a range between 1800K and 3000K, and a value of maximum permissible exposure time (MPE) of the colored light is significantly increased in case of the first illuminance being down regulated to be less than 100 lux:
an ambient light sensor; and
a microprocessor, being integrated in the display device, and being coupled to the ambient light sensor and the display processor;
wherein the microprocessor comprises at least one embedded program including instructions for:
controlling the ambient light sensor to detect a second illuminance of an ambient light flooding the environment;
calculating an illuminance difference between the second illuminance of the ambient light and the first illuminance of the colored light; and
transmitting an illuminance regulating signal to the display processor in case of the illuminance difference being greater than a pre-determined value, thereby making the display processor further down regulate the first illuminance of the colored light to approach the second illuminance of the ambient light.

2.-3. (canceled)

4. The display device of claim 1, being integrated in an electronic device that is selected from the group consisting of television, laptop computer, all-in-one computer, tablet computer, and smartphone.

5. The display device of claim 1, wherein the light parameter regulating unit is selected from the group consisting of color temperature lowering film, optical filter film with functionality of short-wavelength light filtering, and wavelength conversion film.

6.-18. (canceled)
